(19) United States
(12) Patent Application Publication
(10) Pub. No.: US 2026/0051748 A1
(43) Pub. Date: Feb. 19, 2026

(54) ALL-IN-ONE SOLAR-POWERED GUITAR AND CASE SYSTEM

(71) Applicant: Journey M Ralbovsky, Woodstock, NY (US)

(72) Inventor: Journey M Ralbovsky, Woodstock, NY (US)

(21) Appl. No.: 18/808,207

(22) Filed: Aug. 19, 2024

(51) Int. Cl. H02J 7/35; G10D 1/08; G10D 3/00; G10G 7/00; G10G 7/02; G10H 1/34; H02J 7/00; H02S 99/00

(52) U.S. Cl. CPC H02J 7/35; G10D 1/085; G10D 3/00; G10G 7/005; G10G 7/02; G10H 1/34; H02J 7/0042; H02J 7/0048; H02S 99/00

(57) ABSTRACT

The present disclosure provides a guitar case system comprising a clear vinyl guitar case, a plurality of solar fuel cells integrated into the exterior of the guitar case, a charging station connected to the solar fuel cells, and a plurality of storage compartments integrated into the guitar case. The charging station is configured to charge electronic devices stored in the compartments. The system enables musicians to efficiently organize and power their equipment while traveling, reducing reliance on external power sources and improving overall performance capabilities.

### CROSS-REFERENCE TO RELATED APPLICATIONS

### Copyright Statement

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants make no claim to any trademarks referenced.

### BACKGROUND OF THE INVENTION

### 1) Field of the Invention

The invention relates in general to the field of musical instrument accessories and power systems, and more particularly to a solar-powered guitar and case system with integrated charging capabilities and ergonomic design features.

### 2) Description of Related Art

Currently the state of the art includes various string musical instruments, particularly guitars. Guitars have long been essential tools for musicians and performers and are used in a large percentage of today's popular music. As the music industry has developed, so too have the needs of traveling musicians who must balance their artistic pursuits with the practical challenges of touring and performing in various locations. Traditional guitar cases and accessories have often fallen short in addressing the multifaceted requirements of modern musicians, especially women performers who face unique ergonomic and organizational challenges.

The advent of acoustic-electric guitars has introduced additional complexities, including the need for power sources to operate built-in electronics such as equalizers, preamps, and tuners. Conventional solutions typically rely on disposable batteries, which can be unreliable and environmentally unsustainable. Moreover, the increasing reliance on electronic devices for music production, performance, and communication has created a demand for integrated power solutions that can support both the instrument and auxiliary equipment.

Traveling musicians often struggle with the limitations of standard guitar cases, which may lack adequate storage for essential accessories, personal items, and electronic devices. This deficiency can lead to disorganization and inconvenience, particularly when navigating through airport security or preparing for performances in varied settings. Additionally, the opaque nature of traditional guitar cases can sometimes complicate security screenings and increase the time and stress associated with travel.

Furthermore, the design of standard acoustic guitars has historically failed to fully consider the anatomical differences among players, particularly women. This oversight can result in discomfort, poor posture, and potential long-term health issues for performers who must maintain extended playing sessions.

As environmental concerns become increasingly prominent, there is a growing interest in sustainable and eco-friendly solutions across all industries, including musical equipment. However, the integration of renewable energy sources into musical instruments and their accessories has been limited, leaving room for innovation in this area.

The music industry continues to seek improvements that can enhance the functionality, comfort, and sustainability of instruments and related equipment. Addressing these challenges could significantly improve the experiences of traveling musicians and potentially open new possibilities for performance and creativity.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide an all-in-one solar-powered guitar and case system.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a guitar case system is provided. The guitar case system includes a clear vinyl guitar case. The system includes a plurality of solar fuel cells integrated into the exterior of the guitar case. The system includes a charging station connected to the solar fuel cells. The system includes a plurality of storage compartments integrated into the guitar case. The charging station is configured to charge electronic devices stored in the compartments.

According to other aspects of the present disclosure, the guitar case system may include one or more of the following features. The system may include a fanny pack attachable to the guitar case. The storage compartments may include dedicated spaces for an iPad, phone, harmonicas, capos, makeup, toiletries, and clothing items. The clear vinyl guitar case may be available in standard size, 3/4 size, and travel size versions. The charging station may include multiple USB ports for connecting electronic devices. The system may include a power bank connected to the charging station for storing excess solar energy. The power bank may be removable and can be used separately from the guitar case.

According to another aspect of the present disclosure, a guitar system is provided. The guitar system includes an acoustic-electric guitar body. The system includes a solar-powered equalizer/preamp/tuner unit integrated into the upper bout of the guitar body. The system includes a rechargeable battery connected to the equalizer/preamp/tuner unit. The system includes an on/off switch for the equalizer/preamp/tuner unit. The system includes a solar-powered tuner clipped into the sound hole of the guitar.

According to other aspects of the present disclosure, the guitar system may include one or more of the following features. The guitar body may be ergonomically shaped to accommodate a female player's anatomy. The system may include solar cells integrated into the surface of the equalizer/preamp/tuner unit. The rechargeable battery may be a lithium-ion battery. The rechargeable battery may be removable and replaceable. The solar-powered tuner clipped into the sound hole may be detachable. The detachable solar-powered tuner may include a display visible to the player during performance.

According to another aspect of the present disclosure, a method of powering a guitar system is provided. The method includes collecting solar energy via solar cells on a guitar case. The method includes storing the collected energy in a battery. The method includes powering an equalizer/preamp/tuner unit on a guitar using the stored energy.

According to other aspects of the present disclosure, the method may include one or more of the following features. The method may include powering electronic devices stored in compartments of the guitar case using the stored energy. The electronic devices may include at least one of a phone, tablet, or tuner. The method may include displaying a battery charge level on the equalizer/preamp/tuner unit. Displaying the battery charge level may comprise illuminating a series of LED indicators. The method may include automatically switching to a backup battery when the charge level falls below a predetermined threshold.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention which is directed to a guitar case system comprising:
a. a clear vinyl guitar case;
b. a plurality of solar fuel cells integrated into the exterior of the guitar case;
c. a charging station connected to the solar fuel cells;
d. a plurality of storage compartments integrated into the guitar case; and
e, wherein the charging station is configured to charge electronic devices stored in the compartments.

The instant invention can further comprise a fanny pack attachable to the guitar case.

The instant invention can also be described as comprising of storage compartments that include dedicated spaces for an mobile devices such as an iPad, phone, harmonicas, capos, makeup, toiletries, and clothing items.

The instant invention can further be described as a soft case made of clear vinyl wherein the clear vinyl guitar case is available in standard size, 3/4 size, and travel size versions.

The instant invention, wherein the charging station includes multiple USB ports for connecting electronic devices.

The instant invention further comprises a power bank with a charge controller to monitor and protect the batteries and is connected to the charging station for storing excess solar energy.

The instant invention, wherein the power bank is removable and can be used separately from the guitar case or removed to facilitate checking the guitar case in checked luggage.

The instant invention in an alternative embodiment can be further be described as a guitar system comprising:
a. an acoustic-electric guitar body;
b. a solar-powered equalizer/preamp/tuner unit integrated into the upper bout of the guitar body;
c. a rechargeable battery connected to the equalizer/preamp/tuner unit;
d. an on/off switch for the equalizer/preamp/tuner unit; and
e. a solar-powered tuner clipped into the sound hole of the guitar.

The alternative embodiment can further be described wherein the guitar body is ergonomically shaped to accommodate a female player's anatomy by providing a recess for a female breast.

The alternative embodiment can further be described as a guitar as comprising solar cells integrated into the surface of the equalizer/preamp/tuner unit.

The alternative embodiment can further be described wherein the rechargeable battery is a lithium-ion battery or other secondary battery capable of storing chemical energy.

The alternative embodiment can further be described wherein the rechargeable battery is removable and replaceable.

The alternative embodiment can further be described wherein the solar-powered tuner clipped into the sound hole is detachable.

The alternative embodiment can further be described wherein the detachable solar-powered tuner includes a display visible to the player during performance.

The instant invention in an second alternative embodiment can be further as a method of powering a guitar system, comprising:
a. collecting solar energy via solar cells on a guitar case;
b. storing the collected energy in a battery; and
c. powering an equalizer/preamp/tuner unit on a guitar using the stored energy.

The instant invention in an second alternative embodiment can be further be described as a guitar system capable of powering electronic devices stored in compartments of the guitar case using the stored energy.

The instant invention in a second alternative embodiment can be further described as wherein the electronic devices include at least one of a mobile device, phone, tablet, or tuner.

The instant invention in a second alternative embodiment can be further described as comprising displaying a battery charge level on the equalizer/preamp/tuner unit and a charge controller for controlling the discharge and charging of the removable battery.

The instant invention in a second alternative embodiment can be further described as wherein displaying the battery charge level comprises illuminating a series of LED indicators and a having charge controller for controlling the discharge and charging of the removable battery.

The instant invention in a second alternative embodiment can be further described as further comprising automatically switching to a backup battery when the charge level falls below a predetermined threshold.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows the prior art of a drawing of a woman playing a guitar of the instant invention;

FIG. 2 is a rear perspective of the prior art with a relief/insert in the back of the guitar for a woman's breast;

FIG. 3 show a view of a woman's breast contacting the relief/insert in the back of the guitar of the prior art;

FIG. 4 is a drawing of the prior art showing back of the guitar and the right-hand side of the guitar;

FIG. 5 shows a prior art typical soft case with a pocket.

FIG. 6 is a drawing showing the front view;

FIG. 7 is a right-side view of the instant invention guitar case;

FIG. 8 is a drawing showing the back view of the instant invention guitar case;

FIG. 9 is a left-side view of the instant invention guitar case;

FIG. 10 shows a left side view of the instant invention guitar case;

FIG. 11 shows a perspective view of the guitar body of the instant invention;

FIG. 12 shows a drawing showing the guitar of the instant invention connected to the power supply on the guitar case of the instant invention;

FIG. 13 shows a drawing showing the front view of a guitar case of the instant invention;

FIG. 14 shows a drawing showing the right-side view of a guitar case of the instant invention;

FIG. 15 shows a drawing showing the right-side perspective view of a guitar case of the instant invention;

FIG. 16 shows a drawing showing the front view of a guitar case of the instant invention made from clear vinyl and showing personal items in the pocket;

FIG. 17 shows a drawing showing the right-side of a guitar case of the instant invention made from clear vinyl and showing personal items in the multiple pockets;

FIG. 18 is a front perspective of the instant invention case;

FIG. 19 shows the guitar case with special crease; and

FIG. 20 shows the charging device schematic.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term guitar as used in the specification is meant to mean a string instrument.

The terms controller, solar controller, charge/discharge controller and charge controller are used interchangeably in the specification and are meant to mean a controller that is capable of controlling the charging, discharging and monitoring of a battery.

The term guitar as used in the specification is meant to mean a musical instrument.

The term case as used in the specification is meant to mean a case for a musical instrument and it can either be made from a soft compliant material or a hard protective case to protect the musical instrument from damage.

The term power source, battery, rechargeable battery, cell as used in the specification of the instant invention is meant to mean a battery capable of storing electrons and discharging electrons.

The terms solar cell and solar panel are used interchangeably in the specification and are meant to mean a solar panel that collects solar energy or light energy and converts it to electrical energy.

The terms relief and insert are used interchangeably in the specification and are meant to mean an insert in the back of the guitar that accommodates a female breast when the guitar is worn so that the back of the guitar is proximal to the woman's breast.

Prior to a discussion of the preferred embodiment of the invention, it should be understood that while the features and advantages of the invention are illustrated in terms of a musical instrument and a case for carrying or storing a musical instrument.

The instant invention in one aspect is an All-In-One Guitar necessity package solar system unit and back-up power to reduce the dilemmas of performing to reduce difficulties in incorrect anatomical posture, ergonomic positioning, migration inconvenience, acoustical electrical sound outage and tuning complications.

During a performances, the musician has many issues to address and some of those are directly related to the travel and venue and the instant invention is a catchall package that has various unique features to simplify the musicians' experience. The instant invention focuses on the problems that a female musician has to endure and allows them to be more efficient, self-sufficient, and economic in packing, traveling and performing. The instant invention streamlines every aspect of a female musicians' life of music, performance, self-care and even general maintenance. Also, this may seem indirect, but going through airport security is relevant under these aspects. What is involved in getting there through security while working to be packing/traveling light as self-contained efficient style. This well-organized innovation will provide features that make a female musicians life easier.

Traveling/Touring/Transparency for a musician is difficult especially when going through airport security carrying an instrument, one is usually singled out even when using a small travel guitar case made of black canvas. Because the security agents cannot see what is in it the security system flags it as a problem. This usually results in the traveler and the guitar being searched, the case is emptied of all items that I have painstakingly shove in the case which results in a repacking issue after the inspection. Needless to say, a highly unnecessary stressful situation that can be avoided with a Clear Vinyl case.

Another major issue with this plain standard canvas bag is the lack of storage, iPad in only one pocket on the side, no way to charge it, chargers/wires hanging out. Harmonica holder, harmonicas, (half the time no one knows what they are) capos, expensive makeup for easy access, toothbrush, toothpaste, razors, snack, little water bottle, journal, supplements, personal toiletries.

The other consideration is that many times alternative carrying devices such as a fanny pack are needed to carry the travelers phone, id, credit cards, etc. The instant invention solve the issue with the pockets both exterior to the case and interior to the case.

The problem with most gig bags made by guitar manufacturers is that they do not have taken into account that bag or case must serve multiple functions. The working musician needs to travel with a variety of items, and they need them readily available, so the instant invention solves those problems by providing a case with pockets and charging facilities. The ability to charge a travelers mobile device, iPad, tuners, computer and iPhone is very time consumer and requires a lot of time where one can perform and do other necessary items. The instant invention has a built-in charger that allows the traveler to charge their electronic devices while traveling instead of forcing them to be tied to electrical outlets to charge these items.

The instant invention solves the issue of Power for a musicians' electronic devices by incorporating a solar charging system comprised of at least one solar panel, at least one battery and at least one charge/discharge controller. The controller can also be connected to a micro controller and a communication device to provide additional features for the musician. As a performer with an acoustic electric guitar player, one needs to have power in what is standard (as an equalizer/preamp/and built in tuner) so during performance power is turning acoustic into a magnification of the natural sound. The guitar of the instant invention has a device, located in the upper-bout shoulder on top of the shoulder of the guitar body directly above the woman's cavity as shown in the various figures. It adjusts the frequency, bandwidth and tunes the strings on the actual guitar. This multi-purpose device is normally powered by a 9-volt battery which usually runs out on most performers one time or another, is disposable and stops working, especially during those “Your On” show times. It is also difficult to replace. As most guitar players will testify, the battery can also be drained if the acoustic electric is left plugged into the guitar when taking a break. The instant invention has also addressed this with a simple on/off switch to make sure that the guitar can still be left on stage in the stand waiting for the next set.

Also, when the jack is prematurely pulled out before communicating with the sound person, can result in a crackling sound which is annoying to the crew and the audience. The instant invention currently uses DBTLAP-LIR2477 rechargeable batteries for the solar tuner in the sound hole and for the multi-layered system with the on/off/tuner/equalizer/preamp is another rechargeable ML2032. However, any useable rechargeable battery is acceptable.

Performance/Posture/Anatomy as if performing was not nerve racking enough, all the standard size acoustic guitars for years as well-crafted as they are, no one has since catered an acoustic guitar for women. The three main problems with the standard size acoustic/electric guitars is that when women are holding and playing the guitar when the strap is at a certain level or those women who like to play ‘high’ or sitting on a chair or a stool must contend with where the breast must go with respect to the guitar. The instant invention solves that problem by providing relief/insert in the guitar for the female breast and therefore the guitar can be closer to the body. The guitar system is therefore anatomically correct so that the individual can perform better and improves the singing technique and posture. The relief/insert can be the injection mold to match the individual's breast. The relief/insert can also be molded with fiberglass, wood and plastics such as ABS, polystyrene, polyethylene etc. The relief/insert can also be made with carbon fiber or any other suitable material.

When traveling the transparency of the case is helpful when confronted with security inspections. The instant invention provides a case that is easily inspected and has solar panels that absorbs light either man made or solar and converts the light into electrical energy. The solar panels can be soft or rigid panels depending on the design of the instant invention. Therefore, your guitar bag can be either hard or soft with solar or fuel cells collecting light energy and charging the associated batteries so they can be used to charge the assorted electrical devices used by the musician.

The instant invention is designed to be self-sufficient without having to be contingent on whether you remembered your tuner, your batteries or your special eyeliner and eyelashes. This whole necessity solar system package also offers “standard size, 3/4 size and travel size” guitar cases as well as the number and size of the solar panels. The case can also be made from either clear vinyl for basic transparency or standard material s with clear windows. The instant invention case can also have extra compartments and pockets designed to hold any number of items needed by traveling musicians. The solar powered case is also connected to the preamp, equalizer, tuner which is part and parcel of the instant invention solar system unit.

The power/efficient solar system of the instant invention provides a unit that is ecological and self-sufficient without having to rely on a regular 9-volt battery. Using a rechargeable battery which does not have to be replaced makes the musicians' job easier. Not having to depend on electricity for a certain amount of time when out and about makes travel decisions easier. Also, when in crucial low light situations, there is also a solar-powered tuner clamped into the sound hole to ensure adequate power in all conditions and a satellite for the electric guitar. The solar system unit of the instant invention has a modification of the normal equalizer/preamp/tuner being made from plastic, here the instant invention turned that surface area where your volume, equalizer, tuners are placed into useful solar power controller or charge discharge controller.

The following description sets forth exemplary aspects of the present disclosure. It should be recognized, however, that such a description is not intended as a limitation on the scope of the present disclosure. Rather, the description also encompasses combinations and modifications to those exemplary aspects described herein.

The present disclosure provides a comprehensive system designed to address the multifaceted needs of musicians, particularly those who travel frequently for performances. This system integrates a solar-powered guitar and a specially designed case, offering a unique combination of functionality, convenience, and sustainability. The guitar case, made of clear vinyl, incorporates solar fuel cells and a charging station, enabling the storage and charging of electronic devices. Whereas in the preferred embodiment the case is made from clear vinyl in the spirit of the invention the case can also be a hardshell guitar case made from fiberglass, wood, and plastic and the case is lined with a soft material such as velvet or velour fabric however any soft protective fabric can be used. When the case is made from a soft material it can be made from vinyl, canvas, woven nylon, such as Cordura®, ballistic, or ripstop. The case of the instant invention can also feature multiple storage compartments, designed to accommodate a variety of items essential for traveling musicians.

The guitar within this system is an acoustic-electric model equipped with a solar-powered equalizer, preamp, and tuner unit. It alternatively be an electric guitar. This guitar of the instant invention has a solar-powered equalizer, preamp, and tuner unit integrated into the upper bout of the guitar body, is connected to a rechargeable battery, ensuring reliable power supply for the guitar's electronics. An additional solar-powered tuner, clipped into the guitar's sound hole, provides further convenience for the musician.

Notably, the guitar body is designed with an ergonomic shape, taking into consideration the anatomical differences among players, particularly women. This design aims to enhance comfort and promote better posture during performances.

The integration of solar power into both the guitar and its case offers an eco-friendly solution, reducing reliance on disposable batteries and providing a sustainable power source for the guitar's electronics and other devices. This system, therefore, presents a novel approach to addressing the practical challenges faced by traveling musicians, while also contributing to environmental sustainability.

In some aspects, the guitar case system may comprise a clear vinyl guitar case. However, a hardshell guitar case is made from fiberglass, wood, and plastic and the case is lined with a soft material such as velvet or velour fabric however any soft protective fabric can be used. When the case is made from a soft material it can be made from vinyl, canvas, woven nylon, such as Cordura®, ballistic, or ripstop. When the case is made from clear vinyl use for the case it is designed to provide transparency into the case, allowing for easy identification of the contents within the case. An alternate design could have a woven nylon or other sheet material with clear vinyl windows to allow the user or security to see into the case. The clear vinyl case or window feature may be particularly beneficial for musicians traveling through airport security, as it may reduce the need for extensive searches and unpacking of the case. The clear vinyl material may also offer durability and resistance to wear and tear, ensuring the longevity of the case.

The guitar case system may also include a plurality of solar or fuel cells integrated into the exterior of the guitar case. These solar or fuel cells may be strategically positioned on the case to maximize exposure to sunlight, thereby optimizing the collection of solar energy. The solar cells may convert the collected solar energy into electrical energy, which can be stored and used to power electronic devices.

In some cases, the guitar case system may include an acoustic-electric guitar or other guitar body, but acoustic-electric guitar body is the preferred. The guitar body may be designed with a focus on ergonomics and comfort, particularly for female players. The shape and design of the guitar body may take into account the anatomical differences among players, aiming to enhance comfort and promote better posture during performances. This may involve, for example, a contour or indentation in the upper bout of the guitar body to accommodate a female player's anatomy.

In some embodiments, the acoustic-electric guitar body may be equipped with a solar-powered equalizer, preamp, and tuner unit. This unit may be integrated into the upper bout of the guitar body, providing easy access for the player. The equalizer, preamp, and tuner unit may be powered by a rechargeable battery, which may be charged using the solar energy collected by the solar fuel cells on the guitar case. This integration of solar power into the guitar system may provide a sustainable and reliable power source for the guitar's electronics, reducing reliance on disposable batteries and offering convenience for the musician.

In some aspects, the clear vinyl guitar case may be available in various sizes to accommodate different types of guitars. For instance, the case may be available in standard size, 3/4 size, and travel size versions. This range of sizes may allow musicians to choose a case that best fits their specific guitar, ensuring optimal protection and convenience during travel.

In some cases, the clear vinyl guitar case may feature a crease or fold line to facilitate easier opening and closing of the case. This crease may be strategically positioned to allow the case to open wide enough for the guitar to be easily inserted or removed, while also enabling the case to fold neatly when closed. This design feature may enhance the usability of the case, making it more convenient for musicians to handle their guitars during travel and performances.

In some embodiments, the clear vinyl material of the guitar case may offer additional benefits beyond its transparency. For example, the clear vinyl material may be resistant to water and other environmental elements, helping to protect the guitar and other stored items from potential damage. Furthermore, the clear vinyl material may be easy to clean, allowing musicians to maintain the appearance and hygiene of their case with minimal effort.

In some aspects, the clear vinyl guitar case may be designed with a focus on maximizing the efficiency of the integrated solar fuel cells. For instance, the case may be structured in a way that positions the solar fuel cells towards the sun when the case is carried or placed in a typical manner. This design consideration may enhance the collection of solar energy, thereby improving the overall efficiency of the solar-powered system.

In some aspects, the guitar case system may include a plurality of solar fuel cells integrated into the exterior of the guitar case. These solar fuel cells may be strategically positioned on the case to maximize exposure to sunlight, thereby optimizing the collection of solar energy. The solar fuel cells may convert the collected solar energy into electrical energy, which can be stored and used to power electronic devices. The solar fuel cells may be sewn into windows of the bag, providing a seamless integration with the case design while ensuring maximum exposure to sunlight.

In some cases, the solar fuel cells may be arranged in a specific pattern or configuration on the exterior of the guitar case to optimize the collection of solar energy. For instance, the solar fuel cells may be arranged in a grid pattern, a circular pattern, or any other pattern that maximizes the surface area exposed to sunlight. The specific arrangement of the solar fuel cells may depend on various factors, such as the size and shape of the guitar case, the type and efficiency of the solar fuel cells, and the typical orientation of the case during use.

In some embodiments, the solar fuel cells may be flexible, allowing them to conform to the shape of the guitar case. This flexibility may enhance the durability of the solar fuel cells, as they may be less prone to damage from bending or flexing of the case. Furthermore, flexible solar fuel cells may provide a more aesthetically pleasing integration with the guitar case, as they may blend seamlessly with the case design.

In some aspects, the solar fuel cells may be removable or replaceable. This feature may allow for easy maintenance or upgrade of the solar fuel cells, enhancing the longevity and versatility of the guitar case system. For instance, if a solar fuel cell becomes damaged or less efficient over time, it may be easily replaced with a new one. Alternatively, if more efficient or advanced solar fuel cells become available in the future, they may be easily integrated into the existing guitar case system.

In some cases, the solar fuel cells may be covered with a protective layer or coating to protect them from environmental elements, such as rain, dust, or UV radiation. This protective layer may be transparent to allow sunlight to reach the solar fuel cells, while providing a barrier against potential damage. The protective layer may be made of a durable material, such as a clear plastic or a UV-resistant coating, to ensure the longevity of the solar fuel cells.

In some aspects, the guitar case system may include a charging station connected to the solar fuel cells. The charging station may be configured to convert the solar energy collected by the solar fuel cells into electrical energy, which can be stored and used to power electronic devices. The charging station may be integrated into the guitar case, providing a convenient and accessible power source for musicians on the go.

In some embodiments, the charging station may include multiple USB ports for connecting electronic devices. These USB ports may allow for the simultaneous charging of multiple devices, such as a phone, tablet, or tuner. The number and configuration of the USB ports may vary depending on the specific needs and preferences of the user. For instance, the charging station may include two, three, four, or more USB ports arranged in a row, a circle, or any other configuration that optimizes the use of space and accessibility.

In some cases, the charging station may be equipped with a power management system to optimize the charging process. This system may monitor the power levels of the connected devices and adjust the charging rate, accordingly, ensuring efficient use of the stored solar energy. The power management system may also provide protection against overcharging, short circuits, and other potential issues, enhancing the safety and reliability of the charging station.

In some aspects, the charging station may be designed with a user-friendly interface, providing clear and intuitive controls for the user. This interface may include indicators for the power levels of the charging station and the connected devices, as well as controls for starting, stopping, or adjusting the charging process. The interface may be designed with simplicity and ease of use in mind, making it accessible to musicians of all levels of technical proficiency.

In some embodiments, the charging station may be removable or detachable from the guitar case. This feature may provide flexibility for the user, allowing them to use the charging station separately from the case if desired. For instance, the user may choose to detach from the charging station and use it as a standalone solar charger when they are not traveling with their guitar. This detachable design may enhance the versatility and convenience of the guitar case system.

In some aspects, the guitar case system may include a plurality of storage compartments integrated into the guitar case. These compartments may be designed to accommodate a variety of items essential for traveling musicians. For instance, the compartments may include dedicated spaces for an iPad, phone, harmonicas, capos, makeup, toiletries, and clothing items. These dedicated spaces may be designed to securely hold the respective items, preventing them from moving around inside the case during travel. The compartments may be arranged in a specific configuration within the case to optimize the use of space and accessibility of the items.

In some cases, the storage compartments may be designed with specific features to enhance their functionality. For instance, the compartments for electronic devices such as an iPad or phone may include padding or cushioning to protect the devices from impact or vibration. The compartments for harmonicas and capos may include elastic bands or straps to securely hold the items in place. The compartments for makeup and toiletries may be lined with a waterproof or spill-resistant material to prevent any leaks or spills from damaging the guitar or other items in the case.

In some embodiments, the guitar case may include additional storage compartments for items such as sunglasses and hairbrushes. These compartments may be located in convenient locations on the case, such as on the exterior or near the top of the case, for easy access. The compartments for sunglasses and hairbrushes may be designed with specific features to protect these items, such as padding for the sunglasses and a secure closure for the hairbrush compartment.

In some aspects, the storage compartments may be customizable or adjustable to accommodate different items or preferences of the user. For instance, the compartments may include adjustable dividers or removable inserts that allow the user to customize the size and arrangement of the compartments. This feature may provide flexibility for the user, allowing them to adapt the storage compartments to their specific needs and preferences.

In some cases, the storage compartments may be designed with transparent or semi-transparent material, allowing the user to easily see the contents of the compartments. This feature may be particularly beneficial for musicians who need to quickly locate specific items during performances or rehearsals. The transparent material may also facilitate the process of going through airport security, as it allows security personnel to easily see the contents of the compartments.

In some aspects, the guitar case system may further comprise a fanny pack that is attachable to the guitar case. This fanny pack may provide additional storage space for items that the musician may need to access quickly or frequently, such as a phone, ID, credit cards, or other personal items. The fanny pack may be designed to attach securely to the guitar case, ensuring that it stays in place during travel and performances. The attachment mechanism may involve straps, hooks, Velcro, or any other suitable means. In some cases, the fanny pack may be designed to blend seamlessly with the guitar case, creating a unified and aesthetically pleasing appearance.

In some embodiments, the fanny pack may be detachable from the guitar case, allowing the musician to use it separately if desired. This feature may provide flexibility for the musician, allowing them to carry only the essentials when they are not performing or traveling with their guitar. The detachable design may also facilitate the process of going through airport security, as it allows the musician to quickly and easily separate their personal items from their musical equipment.

In some cases, the guitar case may include a mirror. This mirror may be integrated into one of the storage compartments, providing a convenient tool for musicians who need to check their appearance before performances. The mirror may be made of a durable and shatter-resistant material, ensuring its longevity and safety. In some aspects, the mirror may be removable or adjustable, allowing the musician to use it in the most convenient and comfortable manner. For instance, the mirror may be attached to the compartment with a swivel mechanism, allowing the musician to adjust its angle as needed. In other cases, the mirror may be detachable, allowing the musician to use it separately from the guitar case.

In some aspects, the acoustic-electric guitar body may be designed with a focus on ergonomics and comfort, particularly for female players. The shape and design of the guitar body may take into account the anatomical differences among players, aiming to enhance comfort and promote better posture during performances. This may involve, for example, a contour or indentation in the upper bout of the guitar body to accommodate a female player's anatomy. This modified upper bout shape may provide a more comfortable resting point for the player's chest, reducing strain and discomfort during prolonged performances.

In some cases, the ergonomic design of the guitar body may also include a narrower waist, or a smaller overall size compared to traditional guitar bodies. This may make the guitar easier to hold and play, particularly for players with smaller hands or shorter arms. The ergonomic design may also contribute to a more balanced weight distribution, reducing the risk of muscle strain or fatigue during performances.

In some embodiments, the guitar body may be made from lightweight materials to further enhance its comfort and ease of use. These materials may include, for example, various types of wood, composite materials, or other suitable materials known in the art. The choice of materials may also contribute to the acoustic properties of the guitar, providing a rich and resonant sound.

In some aspects, the guitar body may include a cutaway design in the upper bout. This cutaway may provide easier access to the higher frets on the guitar neck, facilitating more complex playing techniques. The cutaway design may be particularly beneficial for female players, who may find it more difficult to reach the higher frets on traditional guitar bodies due to their typically smaller hand size.

In some cases, the guitar body may include additional features to enhance its usability and comfort. For instance, the guitar body may include a built-in armrest, a contoured back, or a textured surface for improved grip. These features may be designed with the specific needs and preferences of female players in mind, providing a more personalized and comfortable playing experience.

In some aspects, the acoustic-electric guitar body may be equipped with a solar-powered equalizer, preamp, and tuner unit. This unit may be integrated into the upper bout of the guitar body, providing easy access for the player. The equalizer, preamp, and tuner unit may be powered by a rechargeable battery, which may be charged using the solar energy collected by the solar fuel cells on the guitar case. This integration of solar power into the guitar system may provide a sustainable and reliable power source for the guitar's electronics, reducing reliance on disposable batteries and offering convenience for the musician.

In some embodiments, the equalizer, preamp, and tuner unit may include solar cells integrated into its surface. These solar cells may be strategically positioned on the unit to maximize exposure to sunlight, thereby optimizing the collection of solar energy. The solar cells may convert the collected solar energy into electrical energy, which can be stored in the rechargeable battery and used to power the equalizer, preamp, and tuner unit. The integration of solar cells into the equalizer, preamp, and tuner unit may provide a direct and efficient way of harnessing solar energy, enhancing the sustainability and self-sufficiency of the guitar system.

In some cases, the solar cells integrated into the equalizer, preamp, and tuner unit may be flexible, allowing them to conform to the shape of the unit. This flexibility may enhance the durability of the solar cells, as they may be less prone to damage from bending or flexing of the unit. Furthermore, flexible solar cells may provide a more aesthetically pleasing integration with the equalizer, preamp, and tuner unit, as they may blend seamlessly with the unit design.

In some aspects, the solar cells integrated into the equalizer, preamp, and tuner unit may be covered with a protective layer or coating to protect them from environmental elements, such as rain, dust, or UV radiation. This protective layer may be transparent to allow sunlight to reach the solar cells, while providing a barrier against potential damage. The protective layer may be made of a durable material, such as a clear plastic or a UV-resistant coating, to ensure the longevity of the solar cells.

In some embodiments, the solar cells integrated into the equalizer, preamp, and tuner unit may be removable or replaceable. This feature may allow for easy maintenance or upgrade of the solar cells, enhancing the longevity and versatility of the guitar system. For instance, if a solar cell becomes damaged or less efficient over time, it may be easily replaced with a new one. Alternatively, if more efficient or advanced solar cells become available in the future, they may be easily integrated into the existing guitar system.

In some aspects, the equalizer/preamp/tuner unit of the guitar system may be connected to a rechargeable battery. This battery may serve as the primary power source for the unit, providing the necessary energy to operate the equalizer, preamp, and tuner functions. The rechargeable battery may be designed to store a substantial amount of energy, ensuring a reliable and long-lasting power supply for the unit.

In some embodiments, the rechargeable battery may be a lithium-ion battery. Lithium-ion batteries are known for their high energy density, long lifespan, and ability to be recharged hundreds of times without significant loss of capacity. These characteristics make lithium-ion batteries an ideal choice for powering the equalizer/preamp/tuner unit, as they can provide a consistent and reliable power supply over an extended period of time.

In some cases, the rechargeable battery may be removable and replaceable. This feature may allow the user to easily replace the battery if it becomes depleted or damaged, ensuring the continuous operation of the equalizer/preamp/tuner unit. The user may carry a spare battery and replace the depleted one as needed, further enhancing the convenience and usability of the guitar system. The battery compartment may be designed for easy access, allowing the user to replace the battery quickly and without the need for special tools or technical skills.

In some aspects, the equalizer/preamp/tuner unit may include an on/off switch. This switch may allow the user to control the power supply to the unit, enabling them to conserve energy when the unit is not in use. The on/off switch may be conveniently located on the unit, providing easy access for the user. In some cases, the on/off switch may be designed with a clear indicator, such as a light or a color change, to show whether the unit is turned on or off. This feature may provide a visual confirmation of the unit's power status, helping the user to manage the power supply more effectively. The on/off switch of the solar powered equalizer and tuner can have a backup free standing tuner for sound hold as it is all connected from the soft or hard case where the origin of the power comes from for the unit.

In some embodiments, the on/off switch may be integrated into the equalizer/preamp/tuner unit in a way that does not interfere with the operation of the other controls on the unit. For instance, the switch may be located on the side or the back of the unit, away from the knobs or buttons used to adjust the equalizer, preamp, and tuner settings. This design consideration may prevent accidental activation or deactivation of the unit during performance or adjustment of the settings.

In some cases, the on/off switch may be designed with a safety feature to prevent accidental activation or deactivation. For example, the switch may require a certain amount of pressure or a specific motion to operate, reducing the risk of unintentional changes to the power status. This safety feature may be particularly beneficial during performances, where accidental deactivation of the unit could disrupt the sound output.

In some aspects, the on/off switch may be connected to a power management system within the equalizer/preamp/tuner unit. This system may monitor the power levels of the rechargeable battery and automatically turn off the unit when the battery is low, preserving the remaining power for essential functions. The power management system may also automatically turn on the unit when the battery is sufficiently charged, ensuring that the unit is ready for use when needed.

In some aspects, the guitar system may include a solar-powered tuner that is clipped into the sound hole of the guitar. This tuner may be designed to provide accurate and reliable tuning for the guitar, ensuring optimal sound quality during performances. The solar-powered tuner may be powered by a small solar cell integrated into its surface, allowing it to operate independently of the main guitar system. This feature may provide an additional level of convenience for the musician, as they can use the tuner even when the main guitar system is turned off or its battery is depleted.

In some embodiments, the solar-powered tuner may be detachable from the guitar. This feature may allow the musician to remove the tuner when it is not in use, reducing the risk of damage or loss. The detachable design may also facilitate the maintenance and cleaning of the tuner, as it can be easily removed and cleaned separately from the guitar. The tuner may be designed to clip securely into the sound hole of the guitar, ensuring that it stays in place during performances.

In some cases, the solar-powered tuner may include a display that is visible to the player during performance. This display may provide real-time feedback on the tuning of the guitar, helping the musician to maintain optimal sound quality throughout the performance. The display may be designed to be easily readable under various lighting conditions, ensuring that the musician can always see the tuning information clearly. The display may show the current tuning of each string, as well as any necessary adjustments to achieve the desired tuning. In some aspects, the display may also show the power level of the tuner, alerting the musician when the tuner needs to be recharged.

In some aspects, the method of powering the guitar system may involve collecting solar energy via solar cells integrated into the guitar case. These solar cells may be strategically positioned on the case to maximize exposure to sunlight, thereby optimizing the collection of solar energy. The solar cells may convert the collected solar energy into electrical energy, which can be stored for later use. The solar cells may be designed to operate efficiently under various lighting conditions, ensuring a reliable collection of solar energy even in less-than-ideal weather conditions.

In some cases, the collected solar energy may be stored in a battery connected to the solar cells. This battery may be a rechargeable battery, such as a lithium-ion battery, which is known for its high energy density and long lifespan. The battery may be designed to store a substantial amount of energy, ensuring a reliable power supply for the guitar's electronics over an extended period of time. The battery may be located within the guitar case or the guitar itself, providing a compact and convenient power storage solution.

In some embodiments, the stored energy in the battery may be used to power an equalizer/preamp/tuner unit integrated into the guitar. This unit may be designed to enhance the sound quality of the guitar, providing various adjustments to the frequency, bandwidth, and tuning of the strings. The unit may be powered by the stored solar energy, reducing reliance on disposable batteries and offering a sustainable and eco-friendly power solution for the guitar's electronics.

In some aspects, the method of powering the guitar system may also involve distributing the stored energy to other electronic devices stored in the guitar case. These devices may include, for example, a phone, tablet, or additional tuner. The distribution of power may be managed by a charging station integrated into the guitar case, which may include multiple USB ports for connecting the devices. The charging station may be configured to distribute the stored energy efficiently among the connected devices, ensuring optimal use of the solar energy collected by the solar cells.

In some cases, the method of powering the guitar system may include monitoring the power levels of the battery and the connected devices. This monitoring may be performed by a power management system integrated into the charging station or the equalizer/preamp/tuner unit. The power management system may provide alerts or indicators when the power level of the battery or a connected device falls below a certain threshold, allowing the musician to manage the power supply effectively and avoid unexpected power outages during performances.

In some aspects, the guitar case system may include a power bank connected to the charging station. This power bank may serve as a storage unit for excess solar energy collected by the solar fuel cells. The power bank may be designed to store a substantial amount of energy, ensuring a reliable and long-lasting power supply for the guitar's electronics and other devices stored in the case. The power bank may be equipped with a power management system to optimize the charging process and prevent overcharging, enhancing the safety and reliability of the system.

In some embodiments, the power bank may be removable from the guitar case. This feature may provide flexibility for the musician, allowing them to use the power bank separately from the case if desired. For instance, the musician may choose to detach the power bank and use it as a standalone solar charger when they are not traveling with their guitar. This detachable design may enhance the versatility and convenience of the guitar case system.

In some cases, the power bank may include multiple USB ports for connecting electronic devices. These USB ports may allow for the simultaneous charging of multiple devices, such as a phone, tablet, or tuner. The number and configuration of the USB ports may vary depending on the specific needs and preferences of the user. For instance, the power bank may include two, three, four, or more USB ports arranged in a row, a circle, or any other configuration that optimizes the use of space and accessibility.

In some aspects, the power bank may be designed with a user-friendly interface, providing clear and intuitive controls for the user. This interface may include indicators for the power levels of the power bank and the connected devices, as well as controls for starting, stopping, or adjusting the charging process. The interface may be designed with simplicity and ease of use in mind, making it accessible to musicians of all levels of technical proficiency.

In some aspects, the charging station integrated into the guitar case may be configured to charge electronic devices stored in the compartments. The charging station may include one or more USB ports, allowing for the connection of various electronic devices such as a phone, tablet, or tuner. The charging station may be designed to distribute the stored solar energy efficiently among the connected devices, ensuring optimal use of the solar energy collected by the solar fuel cells.

In some cases, the charging station may include a power management system to optimize the charging process. This system may monitor the power levels of the connected devices and adjust the charging rate, accordingly, ensuring efficient use of the stored solar energy. The power management system may also provide protection against overcharging, short circuits, and other potential issues, enhancing the safety and reliability of the charging station.

In some embodiments, the charging station may be designed with a user-friendly interface, providing clear and intuitive controls for the user. This interface may include indicators for the power levels of the charging station and the connected devices, as well as controls for starting, stopping, or adjusting the charging process. The interface may be designed with simplicity and ease of use in mind, making it accessible to musicians of all levels of technical proficiency.

In some aspects, the charging station may be removable or detachable from the guitar case. This feature may provide flexibility for the user, allowing them to use the charging station separately from the case if desired. For instance, the user may choose to detach from the charging station and use it as a standalone solar charger when they are not traveling with their guitar. This detachable design may enhance the versatility and convenience of the guitar case system.

In some cases, the charging station may be designed to be compact and lightweight, minimizing its impact on the overall weight and size of the guitar case. This design consideration may make the guitar case system more convenient and comfortable to carry, particularly for musicians who travel frequently for performances. Despite its compact size, the charging station may be designed to provide a substantial amount of power, ensuring a reliable and long-lasting power supply for the guitar's electronics and other devices stored in the case.

In some aspects, the equalizer/preamp/tuner unit may include a display for indicating the battery charge level. This display may provide real-time information about the current charge level of the rechargeable battery, helping the musician to manage the power supply effectively. The display may be designed to be easily readable under various lighting conditions, ensuring that the musician can always see the battery charge level clearly.

In some embodiments, the battery charge level may be indicated by illuminating a series of LED indicators. These LED indicators may be arranged in a row or a circle on the equalizer/preamp/tuner unit, providing a visual representation of the battery charge level. The number of illuminated LED indicators may correspond to the current charge level of the battery, with more LED indicators being illuminated when the battery is fully charged, and fewer LED indicators being illuminated when the battery is low on charge.

In some cases, the LED indicators may be color-coded to provide additional information about the battery charge level. For instance, the LED indicators may change color from green to yellow to red as the battery charge level decreases, providing a clear and intuitive indication of the battery status. This color-coding feature may enhance the usability of the equalizer/preamp/tuner unit, making it easier for the musician to monitor and manage the power supply during performances.

In some aspects, the LED indicators may be designed to flash or blink when the battery charge level falls below a certain threshold. This flashing or blinking may serve as a warning signal, alerting the musician that the battery needs to be recharged soon. This feature may help to prevent unexpected power outages during performances, ensuring a reliable and uninterrupted sound output from the guitar.

In some embodiments, the LED indicators may be designed to be energy-efficient, consuming minimal power from the battery. This energy efficiency may help to maximize the battery life, ensuring a longer operating time for the equalizer/preamp/tuner unit. Despite their energy efficiency, the LED indicators may be designed to provide bright and clear illumination, ensuring that the battery charge level can be easily seen even in low-light conditions.

In some aspects, the guitar system may be configured to automatically switch to a backup battery when the charge level of the primary battery falls below a predetermined threshold. This automatic switching may be managed by a power management system integrated into the equalizer/preamp/tuner unit. The power management system may monitor the charge level of the primary battery and initiate the switch to the backup battery when necessary. This feature may help to prevent unexpected power outages during performances, ensuring a reliable and uninterrupted sound output from the guitar.

In some embodiments, the equalizer/preamp/tuner unit may use a rechargeable ML2032 battery as the primary power source. This type of battery is known for its high energy density and long lifespan, making it an ideal choice for powering the equalizer/preamp/tuner unit. The ML2032 battery may be designed to be easily replaceable, allowing the musician to swap out a depleted battery with a fully charged one as needed.

In some cases, the solar-powered tuner clipped into the sound hole of the guitar may use a rechargeable DBTLAP-LIR2477 battery. This type of battery may be chosen for its compact size and high energy density, making it suitable for powering the tuner. The DBTLAP-LIR2477 battery may be designed to be easily replaceable, allowing the musician to swap out a depleted battery with a fully charged one as needed.

In some aspects, the backup battery may be the same type as the primary battery, or it may be a different type. For instance, the backup battery may be another rechargeable ML2032 battery or DBTLAP-LIR2477 battery, or it may be a different type of rechargeable battery known in the art. The choice of backup battery may depend on various factors, such as the power requirements of the equalizer/preamp/tuner unit and the solar-powered tuner, the available space within the guitar system, and the specific needs and preferences of the musician.

A number of implementations have been described. Nevertheless, it will be understood that various modifications may be made without departing from the spirit and scope of the disclosure. Accordingly, other implementations are within the scope of the following claims.

The assembly of all the items into a kit makes it easy for a musician to assemble any combination of devices into one guitar case. The kit could include a guitar case, at least one solar cell/panel, a charge discharged controller, cables, at least one rechargeable battery. The musician or user would ben assemble the guitar case and at least one solar cells/panel, a charge discharged controller, cables, at least one rechargeable battery. The installation is simple and easy for the user because the parts necessary to connect the components of the of the instant invention can be assembled to the guitar case.

A first embodiment of the instant invention can further be described as a guitar case system comprising:
a. a clear vinyl guitar case;
b. a plurality of solar cells integrated into the exterior of the guitar case;
c. a charging/discharging station connected to the solar cells;
d. a plurality of storage compartments integrated into the guitar case;
e, wherein the charging station is configured to charge electronic devices stored in the compartments and charge at least one rechargeable battery.

The first embodiment of the instant invention wherein the guitar case system further comprises a fanny pack attachable to the guitar case.

The first embodiment of the instant invention wherein the guitar case system wherein the guitar case system further includes storage compartments that include dedicated spaces for a tablet, phone, harmonicas, capos, makeup, toiletries, and clothing items.

The first embodiment of the instant invention wherein the guitar case system comprises a clear vinyl guitar case available in standard size, 3/4 size, and travel size versions.

The first embodiment of the instant invention, wherein the charging station includes multiple USB ports for connecting electronic devices.

The first embodiment of the instant invention further comprising a power bank comprised of at least one rechargeable battery connected to the charging station for storing excess solar energy.

The first embodiment of the instant invention, wherein the power bank is removable and can be used separately from the guitar case.

The second embodiment of the instant invention wherein guitar system comprising:
a. an acoustic-electric guitar body;
b. a solar-powered equalizer/preamp/tuner unit integrated into the upper bout of the guitar body;
c. a rechargeable battery connected to the equalizer/preamp/tuner unit;
d. an on/off switch for the equalizer/preamp/tuner unit;
e. a solar-powered tuner clipped into the sound hole of the guitar.

The second embodiment of the instant invention wherein the guitar body is ergonomically shaped to accommodate a female player's anatomy.

The second embodiment of the instant invention wherein the guitar case further comprises solar cells integrated into the surface of the equalizer/preamp/tuner unit.

The second embodiment of the instant invention wherein the rechargeable battery is a lithium-ion battery.

The second embodiment of the instant invention wherein the rechargeable battery is removable and replaceable.

The second embodiment of the instant invention wherein the solar-powered tuner clipped into the sound hole is detachable.

The second embodiment of the instant invention wherein the detachable solar-powered tuner includes a display visible to the player during performance.

A method of powering a guitar system, comprising:
a. collecting solar energy via solar cells on a guitar case;
b. storing the collected energy in a battery;
c. powering an equalizer/preamp/tuner unit on a guitar using the stored energy.

The method further comprises powering electronic devices stored in compartments of the guitar case using the stored energy.

The method wherein the electronic devices include at least one of a phone, tablet, or tuner.

The method further comprises displaying a battery charge level on the equalizer/preamp/tuner unit.

The method wherein displaying the battery charge level comprises illuminating a series of LED indicators.

The method further comprises automatically switching to a backup battery when the charge level falls below a predetermined threshold.

Referring now to the drawings FIG. 1-18, and more particularly to FIG. 1, there is shown a prior art of a drawing of a woman playing a guitar of the instant invention. Referring now to the drawings and to FIGS. 1-3 in particular, FIG. 1 there is shown an acoustical guitar 10 made according to a preferred embodiment of the invention. The guitar 10 has a back 11 and sides 12, 13.

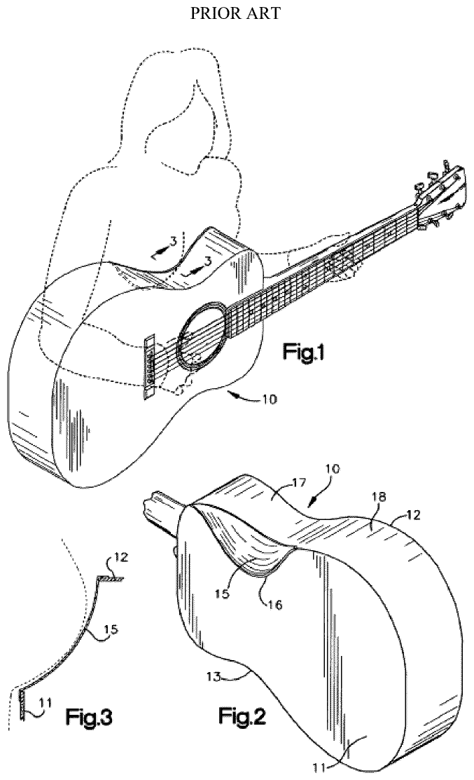

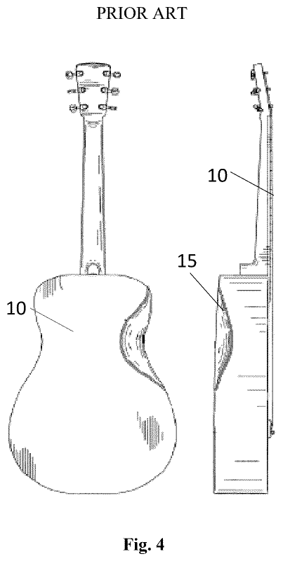

In accordance with the invention, a portion of the back 11 and the side 12 are formed with a relief area or indention 15 which is generally cup shaped. In the case of a female instrumentalist shown in FIGS. 1 and 3, the formation of indention 15 is shaped to accommodate her breast. As shown, the edge 16 of the cup-shaped indention 15 curves from the upper right hand shoulder bout 17 and lower right-hand bout 18 of the side 12 toward the center line of the guitar back 11 and then out to the lower bout in a wave shape. The indention or relief 15 can be molded from plastic, wood, carbon fiber or any suitable material.

In the preferred embodiment of the invention, the breast-accommodating indention 15 is an insert made of any suitable material, such as wood, thin metal or plastic. Preferably, it is made from a material such as a fiber reinforced plastic or other material that can be molded. The insert forming the area 15 can be custom molded to fit the breast of a female user. The insert can be of any desired cup size, e.g. A, B or C to accommodate a particular person, or it can simply be one universal size.

The instant invention solves a significant problem for women that play a standard size acoustic/electric guitar. Women must hold and play the guitar when the strap is at a certain level or those women who like to play ‘high’ or sitting on a chair or a stool must contend with the “rest, the slouch or the pitch.” with the guitar dictating where their breast must go. The upper ridge of the outline of the upper bout on the guitar pushes into the most sensitive midline section of the right bosom. The instant invention solves this problem by providing a guitar that can accommodate a women's breast without crushing it with the back of the guitar.

FIG. 2 is a rear perspective of the prior art with a indention 15 in the back of the guitar for a woman's breast.

FIG. 3 show a view of a woman's breast contacting the indention 15 in the back of the guitar of the prior art.

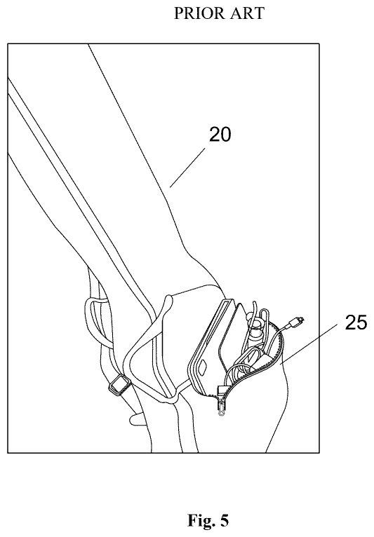

FIG. 4 is a drawing of the prior art showing the back of the guitar 10 and the right-hand side of the guitar 10 with relief 15. Relief 15 can be molded from any suitable material such as plastic, carbon fiber or wood.

FIG. 5 shows a prior art typical soft case 20 with a pocket 25. The guitar case of FIG. 5 is a canvas bag with one pocket. This design does not provide adequate when traveling for storing the necessary travel items need by most women.

As with most guitar cases they are made by guitar manufacturers and their focus is on protecting the guitar and do not provide additional space for a musician that is traveling and must carry a variety of items to support themselves both on stage and off stage. The musician also needs the ability to charge iPad, tuners, computer and smart phones and searching for charging stations is very time consuming and stressful. Therefore, the instant invention provides the facilities to charge various devices using a solar powered charge and discharge system. This allows the musician to charge the various devices when traveling. The instant invention also has a clear see through pockets and case that make it easy for the guitar case to be inspected and the generalized pockets are designed to accommodate carrying clothing. Changing the material from canvas to clear Vinyl with solar power fuel cells provides an improved guitar case for the musician and supports the traveling process.

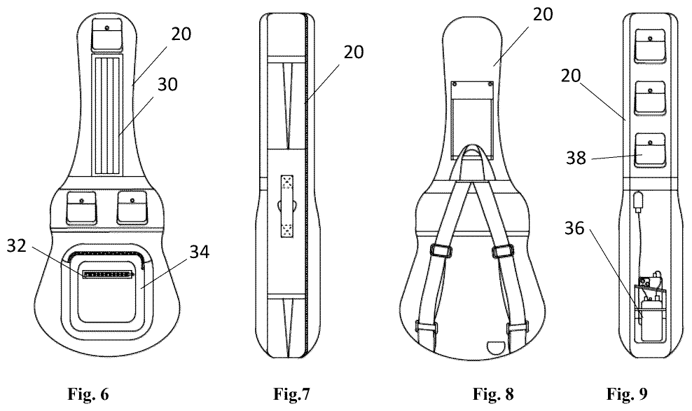

FIG. 6 is a drawing showing the front view of case 20 with solar panel 30 and pocket 34 supporting power pack 32 containing batteries and charge discharge controller. FIGS. 6, 7, 8 and 9 shows a typical guitar case of the instant invention and provides the reader with the general vicinity of the solar panels are placed at the face of the guitar case with various pockets for necessary items of luggage.

FIG. 7 is a right-side view of the instant invention guitar case 20;

FIG. 8 is a drawing showing the back view of the instant invention guitar case 20;

FIG. 9 is a left-side view of the instant invention guitar case 20, pocket 34 and pockets 38.

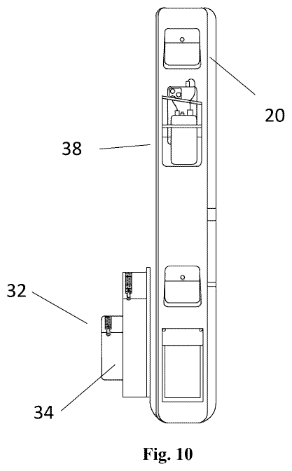

FIG. 10 shows a left side view of the instant invention guitar case 20, pocket 36, pockets 38 and power pack 32 containing batteries and charge discharge controller. FIG. 10 also shows the various pockets and areas for phones, tablets, capos, private items. Also added extra inch in body of guitar as for better light clothing storage. The term capo as used in this disclosure is meant to mean a movable bar attached to the fingerboard of a fretted instrument to uniformly raise the pitch of all the string.

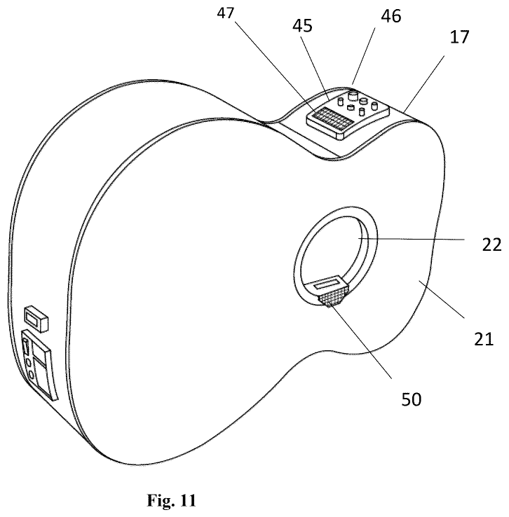

FIG. 11 shows a perspective view of the guitar body 21 of the guitar 10 with relief 15 shown in FIG. 4 of the instant invention. The guitar body 21 has the following features to provide Power and promote efficiency by incorporating a solar system in the guitar case 20, guitar case 20, pocket 36, pockets 38 and power pack 32 containing batteries and charge discharge controller to provide power and charge the associated batteries as shown in FIG. 10. Any performer that uses an acoustic electric guitar player needs to have power to the equalizer, preamp and tuner. During a performance, the power is provided by a battery 40 that is charged by the by the charge and discharge controller in guitar case 20. The power provided to the equalizer, preamp and tuner turns the acoustic guitar sounds into magnified sound. The controller 45 is located in the right-hand shoulder bout 17 on top of the shoulder of the guitar body 21 directly above the woman's cavity is the controller. The controller 45 adjusts the frequency, bandwidth and is used during the tuning of the strings on the actual guitar 10. This controller 45 is normally powered by a 9-volt primary battery that needs to be regularly replaced. Currently most existing guitars are susceptible to power loss because if a performer takes a break without unplugging the jack to the controller the primary battery will be drained thereby requiring it to be replaced. The instant invention has addressed this problem by using a rechargeable secondary battery 47 and adding a switch 46 to turn off the power so the battery life is extended when the guitar is not in use. Also, this design prevents the problem that occurs when the jack is prematurely pulled out before communicating with the sound person. This produces a crackling sound and is disruptive to the performance and the crew. The secondary battery 47 used in the controller 45 of the instant invention include the lithium DBTLAP-LIR2477 rechargeable for the solar tuner 50 in the guitar sound hole 22. The DBTLAP 3.6V LIR2477 Rechargeable Coin Button Cell Battery Can Replace traditional primary CR2477 cell. However, any suitable rechargeable battery can be used such as lithium ion, lithium iron phosphate, sodium, nickel cadmium (Ni—Cd), nickel metal hydride (Ni-MH) or other suitable chemistry. For the multi-layered system with the on/off switch, tuner, equalizer and preamp is another rechargeable battery ML2032 and it can also be replaced by any suitable rechargeable battery can be used such as lithium ion, lithium iron phosphate, sodium, nickel cadmium (Ni—Cd), nickel metal hydride (Ni-MH) or other suitable chemistry.

FIG. 11 shows the controller placement the solar receptors on the equalizer, tuner, preamp with standard knobs, volume, treble, middle and bass. It is located on the upper shoulder near the cavity as seen in FIG. 11. On the bottom side is the battery storage for the main system along with on/off switch. This is usually where the current 9-volt battery is stored but it provides a location for a replacement rechargeable battery. It also shows the placement of the solar power, preamp, on-off switch and tuner in respect to the anatomically correct and ergonomic aspect of the guitar.

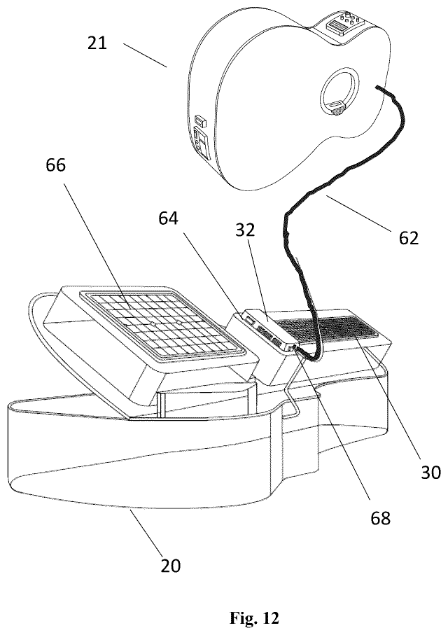

FIG. 12 shows a drawing showing the guitar body 21 of the instant invention connected to the power pack 32 containing batteries and charge discharge controller on the guitar case 20 by cable 62. The power pack 32 has of the instant invention has an on/off switch 64 for turning the charging circuit on and off, and a 9-volt charging port 68 for charging the battery 40 of guitar 10. The guitar case 20 has solar panels 30 and 66 that are connected to the power pack 32. In a separate embodiment the guitar can be powered directly from the power pack 32 containing batteries and charge discharge controller on the guitar case 20 by cable 62.

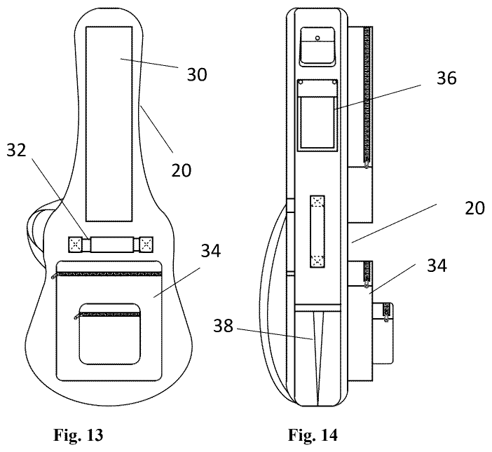

FIG. 13 shows is a drawing showing the front view of an alternate guitar case 20 of the instant invention and, pocket 34 and power pack 32 containing batteries and charge discharge controller. The instant invention provides a guitar case that can be either a hard or soft case that is transparent and has solar cells for collecting solar energy and storing that energy in a charging station that is connected to a rechargeable battery. The charging station can provide power for the guitar or for charging other rechargeable batteries.

An alternative embodiment for the guitar case is a hard case. When the instant invention embodiment is a hard case, it can be fabricated from clear plastic materials such as but not including Lexan®, acrylic, vinyl plexiglass, polycarbonate sheets or any other suitable clear plastic material. This alternative embodiment could also be made from traditional materials such as paper board, wood, plastic and the guitar case fitted with windows to provide visibility into the contents of the guitar case or pockets.

When the case is a soft case, the clear plastic can be selected from vinyl sheets, mylar, polyethylene or any suitable plastic material. A second alternative soft guitar case of the instant invention could use traditional materials such as vinyl, canvas, woven nylon, such as Cordura®, ballistic, or ripstop and have clear windows to provide visibility into the contents of the guitar case or pockets.

FIG. 14 shows a drawing showing the right-side view of an alternate guitar case 20 of the instant invention showing pockets 34, 36 and 38.

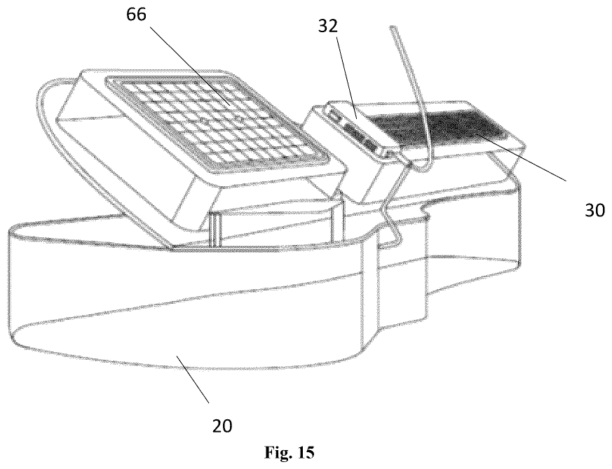

FIG. 15 shows a drawing of the right-side perspective view of an alternate guitar case 20 of the instant invention showing solar panels 66 and 30, and power pack 32. FIG. 15, FIG. 14 and FIG. 13 also show how the multi layered over unity solar equalizer, preamp, tuner integrates with the solar system and how the guitar is connected to the cases themselves where the solar cells are positioned on the front of the case for daily absorption. The solar cells supply the solar energy to support the whole system.

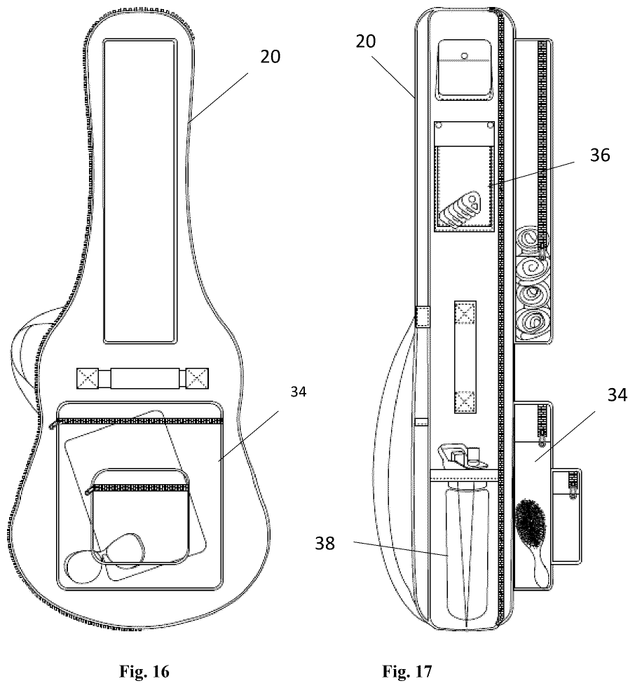

FIG. 16 shows a drawing showing the front view of a guitar case 20 of the instant invention made from clear vinyl and showing personal items in the pocket 34. The clear vinyl allows the items in the guitar case 20 and pocket 34 to be seen without opening the guitar case 20.

The instant invention provides an all-in-one guitar case system designed to be self-sufficient and provides both a power source and a storage for a musicians' guitar. The guitar case also make the contents visible to decrease the inspection time by security when traveling or entering a venue. The solar system package and guitar case of the instant invention can also be customized for use with “standard size, 3/4 size and travel size” guitar cases. By fabricating the guitar case from clear vinyl or other transparent material that permits visibility into the case it makes the case easier for the musician during travel. In some embodiments the extra compartments and pockets designed to provide storage reduces the stress and makes the musicians travel experience more pleasant. The solar powered case which is also connected to the preamp, equalizer and tuner is part of an import part of the instant invention guitar case.

FIG. 17 shows a drawing showing the right-side of a guitar case 20 of the instant invention made from clear vinyl and showing personal items in the multiple pockets 38 and 34 and 36. The clear vinyl allows the items in the guitar case 20 and pocket 34, 36 and 38 to be seen without opening the guitar case 20.

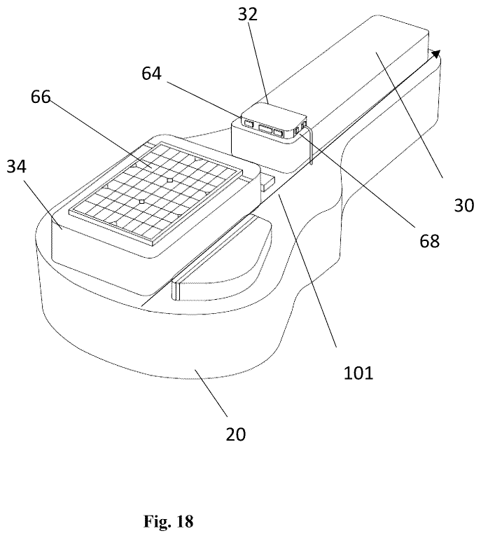

FIG. 18 is a front perspective of an alternative of the instant invention guitar case 10. The pocket 34, solar panel 66 and solar panel 30, power pack 32 containing batteries and charge discharge controller and on/off switch 64, a 9-volt charging port 68 for charging the battery 40 of guitar 10 and special crease 101.

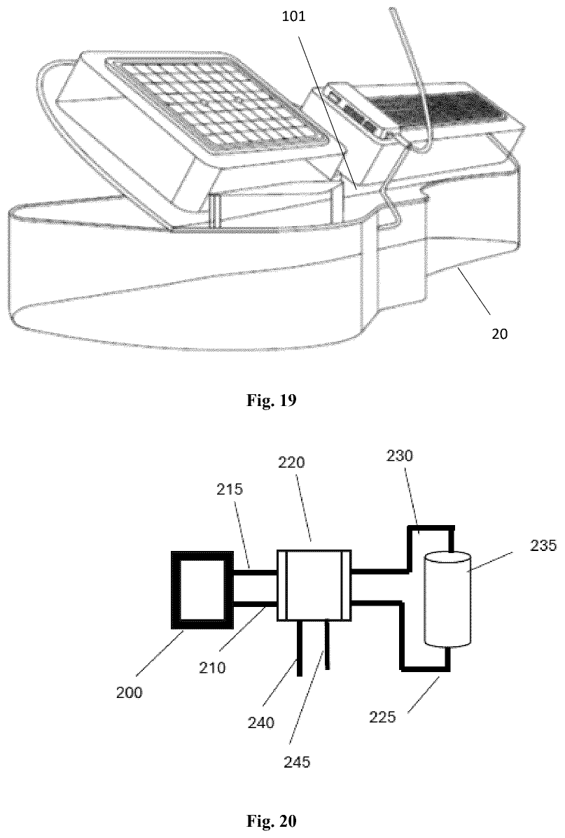

FIG. 19 shows the guitar case 20 with special crease 101. The combination of FIG. 18 and FIG. 19 provides further illustration as to where the solar cells are positioned on the bag and also shows the special crease 101. The crease permits the guitar case to be easily opened and close. The special crease 101 allow the guitar case 20 to be open so that only the top is moved, and the case top does not flop over when opened.

FIG. 20 shows the charging device schematic. A solar battery charging and discharging circuit is designed to safely charge the rechargeable battery and to safely control the discharge of the rechargeable battery to prevent overheating and failure of the battery. It acts as a control circuit to monitor and regulate the process of charging several batteries using a photovoltaic (PV) solar panel 200 or solar cell as the input source for the battery charging process. The positive input solar cells is 210, the negative input is 215, the charge/discharge controller is 220. The charging output for the battery 235 is comprised of the positive output 225 and negative output 230.

The charge/discharge controller is 220, has positive output legs 240 and negative output legs 245. The charge/discharge controller is 220 only allows either charging or discharging of the rechargeable battery at any one time to minimize the issues with overheating the rechargeable battery.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A guitar case system comprising:
a clear vinyl guitar case;
a plurality of solar cells integrated into the exterior of the guitar case;
a charging/discharging station connected to the solar cells;
a plurality of storage compartments integrated into the guitar case;
wherein the charging station is configured to charge electronic devices stored in the compartments and charge at least one rechargeable battery.

2. The guitar case system of claim 1, further comprising a fanny pack attachable to the guitar case.

3. The guitar case system of claim 1, wherein the storage compartments include dedicated spaces for a tablet, phone, harmonicas, capos, makeup, toiletries, and clothing items.

4. The guitar case system of claim 1, wherein the clear vinyl guitar case is available in standard size, 3/4 size, and travel size versions.

5. The guitar case system of claim 1, wherein the charging station includes multiple USB ports for connecting electronic devices.

6. The guitar case system of claim 5, further comprising a power bank comprised of at least one rechargeable battery connected to the charging station for storing excess solar energy.

7. The guitar case system of claim 6, wherein the power bank is removable and can be used separately from the guitar case.

8. A guitar system comprising:
an acoustic-electric guitar body;
a solar-powered equalizer/preamp/tuner unit integrated into the upper bout of the guitar body;
a rechargeable battery connected to the equalizer/preamp/tuner unit;
an on/off switch for the equalizer/preamp/tuner unit;
a solar-powered tuner clipped into the sound hole of the guitar.

9. The guitar system of claim 8, wherein the guitar body is ergonomically shaped to accommodate a female player's anatomy.

10. The guitar system of claim 8, further comprising solar cells integrated into the surface of the equalizer/preamp/tuner unit.

11. The guitar system of claim 8, wherein the rechargeable battery is a lithium-ion battery.

12. The guitar system of claim 11, wherein the rechargeable battery is removable and replaceable.

13. The guitar system of claim 8, wherein the solar-powered tuner clipped into the sound hole is detachable.

14. The guitar system of claim 13, wherein the detachable solar-powered tuner includes a display visible to the player during performance.

15. A method of powering a guitar system, comprising:
collecting solar energy via solar cells on a guitar case;
storing the collected energy in a battery;
powering an equalizer/preamp/tuner unit on a guitar using the stored energy.

16. The method of claim 15, further comprising powering electronic devices stored in compartments of the guitar case using the stored energy.

17. The method of claim 16, wherein the electronic devices include at least one of a phone, tablet, or tuner.

18. The method of claim 15, further comprising displaying a battery charge level on the equalizer/preamp/tuner unit.

19. The method of claim 18, wherein displaying the battery charge level comprises illuminating a series of LED indicators.

20. The method of claim 19, further comprising automatically switching to a backup battery when the charge level falls below a predetermined threshold.
